(19) United States
(12) Patent Application Publication
(10) Pub. No.: US 2026/0055689 A1
(43) Pub. Date: Feb. 26, 2026

(54) METHOD FOR ENERGY STORAGE IN SUBTERRANEAN RESERVOIRS

(71) Applicants: Cliff Mauroner, Denver, CO (US); Henry Lau, Houston, TX (US); Jason Craig, Houston, TX (US); Dagong Zhou, San Francisco, CA (US); Carl Thaemlitz, Tomball, TX (US); Bunker Hill, Sugar Land, TX (US)

(72) Inventors: Cliff Mauroner, Denver, CO (US); Henry Lau, Houston, TX (US); Jason Craig, Houston, TX (US); Dagong Zhou, San Francisco, CA (US); Carl Thaemlitz, Tomball, TX (US); Bunker Hill, Sugar Land, TX (US)

(73) Assignee: Quidnet Energy, Inc, Houston, TX (US)

(21) Appl. No.: 19/298,721

(22) Filed: Aug. 13, 2025

Related U.S. Application Data
(60) Provisional application No. 63/687,156, filed on Aug. 26, 2024.
(60) Provisional application No. 63/687,198, filed on Aug. 26, 2024.

(51) Int. Cl. E21B 43/26; B65G 5/00; E21B 49/00; F03B 17/06

(52) U.S. Cl. CPC E21B 43/26; B65G 5/00; E21B 49/00; F03B 17/06

(57) ABSTRACT

A method for storing high-pressure fluids as energy in a subterranean zone that prevents unwanted vertical fracture propagation and fluid loss irrespective of rock formation having varying pressures relative to the hydrostatic gradient. The method leverages rock properties, changes rock stress, permeability, hydraulic fracturing, fracture sealing materials and previously abandoned oil and gas zones.

### CROSS-REFERENCE TO RELATED APPLICATION

This application claims the benefit of U.S. Provisional No. 63/687,156 filed Aug. 26, 2024, and U.S. Provisional No. 63/687,198 filed Aug. 26, 2024, both of which are hereby incorporated by reference in their entirety herein.

### BACKGROUND OF THE INVENTION

### I. Field of the Invention

The present invention relates to one or more subterranean zones of any lithology that can be used for energy storage. High pressure fluid is stored in a subterranean zone of any lithology. The stored energy can be used to produce useful work above ground. In certain embodiments, portions of the subterranean zone behave as a barrier to prevent fluid leakage and/or contain the fracture from propagating upwards.

### II. Description of the Prior Art

While it is relatively easy for electrical power to move from place to place over long distances, electrical power demand is ever increasing in the United States as it is used, among other things, for lighting, heating, cooling, refrigeration, electronics, machinery, and some transportation systems. Moreover, the frequency of peak power events is increasing as the number of power-hungry devices attached to the North American power transmission grid increases. In the United States, much of the electricity is generated by burning natural gas as a fuel.

Energy storage is needed to balance the large variations in supply and demand to supplement the power generation systems currently in use. High summer temperatures, low winter temperatures, electric powered transportation methods, artificial intelligence (AI) data methods and the like are adding to the power needs of today. Large scale energy storage methods currently include compressed air energy storage (CAES), natural gas cavern storage, pumped hydro, chemical batteries, and subterranean energy storage. Each energy storage system uses different physics and mechanics to achieve the goal of providing energy when it is needed in sufficient quantity. Underground, cavern, and natural gas storage are popular in Europe and other places around the world to store chemical energy until it is needed in the long heating season.

CAES relies on the elasticity of the working fluid and the thermal expansion of the working fluid at the surface to produce useful work. Accordingly, for hydraulic systems like CAES, PE (potential energy)=(½) kx², where: PE is the elastic potential energy (measured in joules, J) k is the spring constant (measured in newtons per meter, N/m) and x is the displacement from the equilibrium position (measured in meters, m).

Pumped hydro is the method of storing energy by pumping water to a higher elevation, storing it, then later allowing the water to fall under gravitational forces to spin a turbine/generator combination to produce electricity. Water is pumped up the hill during off-peak demand periods when electricity is available at a lower cost. For pumped hydro, (potential energy)=mass of water (m)×gravitational acceleration (g) x height difference (h).

Subterranean energy storage is similar to compressed air energy storage (CAES) in that the working fluid is stored underground, however the energy recovery mechanisms are quite different. Both systems can gain some geothermal energy from allowing the natural heat of the earth to warm the working fluid. The subterranean energy storage system relies on the elasticity of the earth and the overburden on the rock where the working fluid is stored and the thermal energy gathered by the working fluid.

In the construction phase of the subterranean energy storage system the well, the subterranean zone, and the surface facilities must be built and/or properly prepared for the operation phase. A subterranean zone can be made up of man-made hydraulic fractures, natural fractures, natural occurring caves, or other fluidically connected geologic features. Not all subterranean systems include fractured formations in the subterranean zone. Some are naturally confined or large enough in size that they do not require hydraulic fracturing or sealing.

For this technology any or all fluidically connected parts can be used to store high pressure fluid. The fluid stored may be used as the working fluid for a system to produce electricity or other useful work below ground or above ground.

The subterranean energy storage zone can be created from a wellbore of any orientation. Vertical, near vertical, horizontal, and near horizontal are some descriptions that have been found in previous patents related to oil and gas wells. Likewise, if fractures are utilized to increase permeability, the fracture direction can be oriented in any direction. Vertical and horizontal are the obvious first choices, however the fractures can be near vertical, near horizontal, T-shaped or non-planar.

Well bores that are placed at an angle greater than 90 degrees are drilled uphill and often called fishhook wells. These wells can be used to contact natural fractures and subterranean zones which may or may not be fractured to make geomechanical energy storage for high pressure fluids. Reference “Asian drilling-intensive projects named finalists for IPTC award.”

The steps to prepare the zone, fracture, store high pressure fluid in the subterranean zone, and then move it to the surface equipment to perform useful work, desalinate water and generate electricity are described in applicant's earlier granted patents, U.S. Pat. Nos. 8,763,387, 9,481,519, 10,125,035 and 11,927,085, all of which are hereby incorporated by reference in their entirety herein. Also hereby incorporated in their entirety herein are applicants'U.S. Pat. No. 11,795,802 describing the creation of fractures in the subterranean zone, sealing it, and preparing it to store high-pressure working fluids which are later moved to the surface to perform useful work; and U.S. Pat. No. 12,123,293 describing other methods to fracture and seal the subterranean zone prior to utilizing it for storage of the high-pressure working fluid.

Essentially, the first step is to collect and evaluate geologic data. Pilot wells may be drilled to collect various geologic data including core samples to verify models. Once a feasible well placement has been determined, one or more wells are drilled, then one or more casing strings are run and cemented in place. Completions are designed and placed in a manner that allows the working fluid to traverse between the wellbore and subterranean zone with the least restriction. In some instances, it may be necessary to sever the upper casing from the lower casing. There are many methods available today to perform this operation which may include techniques such as perforating, fracturing, water jetting, or others to establish a smooth fluid flow path into and out of the subterranean zone for the working fluid through the wellbore.

If permeability enhancement or leak-off reduction is required after the well is constructed, pressure pumping and fluid mixing equipment can be moved to the location. One or more treatment schedules can be injected into the target subterranean zone to artificially modify the permeability of the formation or reduce leakage. The formation can be hydraulically fractured and/or sealed then prepared for the operation phase. These treatments can be injected at any point in the life of the system and they are not limited to only the construction phase, operations phase, or a repair process.

During the operation phase, a working fluid is injected down the well bore, and out into the subterranean zone. Energy is stored in the subterranean zone as high-pressure fluid. Fluid is pumped from a low-pressure storage area to a high-pressure subterranean zone where it can be used immediately or stored for a period of time before being moved to the surface to produce useful work. The high-pressure fluid can, for example, be used with a turbine/generator set to produce electricity. Low-pressure storage can be located at the surface or a subterranean zone.

One or more wells might be used in the subterranean energy storage system. Some may be dedicated to injection or production flow, or a combination of these regimes depending on subterranean zone access and system demands. The fluid is stored under pressure until all, or part of the fluid volume is returned to the surface. In most instances, this high-pressure fluid will be used to produce electricity or perform useful work. The output could be used to power a data center, an industrial plant, a manufacturing center, a food processing plant or some other medium to large scale facility needing energy.

Once such subterranean energy storage facilities are constructed and operational, the stored energy can be released to produce usable work. Fluid can be added at any time to change the chemistry of the working fluid stored, increase the volume of fluid being stored, increase the pressure of the fluid being stored, or to compensate for fluid loss. Likewise, some or all of the working fluid can be released at any time. In order to, convert this stored energy as efficiently as possible, a monitoring and control system needs to be utilized.

If the energy storage system utilizes fractures and they are tough enough and do not leak too much, it may be acceptable to cycle the working fluid into and out of the subterranean zone without placing any sealing material. In some embodiments the fluid stored in the subterranean zone may contain solids.

A single or multi-well well system can be utilized. One or more subterranean zones may also be used. Multi-well systems fluidically connected in subterranean zones are common in hot, dry rock, geothermal systems. Man made hydraulic fractures can be placed between subterranean zones.

Historically, many different materials and techniques have been used in oil and gas wells to stop the flow of water from an underground zone into the well bore. It is important to control the flow of unwanted formation water from entering the well bore in large amounts as the water reduces hydrocarbon flow, increases corrosion, and decreases the life and profitability of the well. This technology goes back nearly 100 years and many different fluid systems are currently available. Such systems have been used in oil and gas wells for different phases of drilling, completion, and production engineering for lost circulation control, drilling fluids, plugging agents, fracturing fluids, water shut off, and water profile control.

Examples of subterranean zones can include, but are not limited to man-made hydraulic fractures, natural fractures, natural occurring caves, conventional fluvial sandstone reservoirs, deltaic sandstone reservoirs, barrier sandstone reservoirs, limestone reefs or other fluidically connected geologic features. For this technology any or all fluidically connected parts can be used to store high pressure fluid. The fluid stored may be used as the working fluid for a system to produce useful work below ground or above ground.

The following terms and definitions are used to describe subterranean zones consisting of geologic formations for oil and gas production, research, and storage. Hydrostatic pressure is a term used to describe the rock's pore pressure at a depth from the earth's surface to the depth studied based on a column of fresh water from sea level to the depth being studied. Geopressure is often defined as the formation pressure which is sometimes higher than the hydrostatic pressure at a given depth due to the compression of clay layers, common when water, natural gas, porous formations, sand, and/or silt are present. Depleted zones or low pressured subterranean zones may include areas where fluids like oil, gas, water, or other minerals or materials have been removed. These are often referred to as underpressured zones. A dry hole is sometimes used in the oil and gas field to describe a well and zone which is not economically feasible to produce due to high lift cost, low volume of reserves, or other reasons. Overpressured zones have high pore pressure that might occur in areas where burial of water-filled sediments by an impermeable sediment such as clay was so rapid that fluids could not escape and the pore pressure increased with deeper burial. Underpressured zones have rock pore pressure less than normal or hydrostatic pressure. These aforementioned definitions can be readily at: https://glossary.slb.com/ which is incorporated by reference herein.

This disclosure includes techniques borrowed from mining, geology as well as the oil and gas industry which are used to characterize materials, stress changes, possible barriers, and modeling techniques. All of these are used to predict the best place for the subterranean zone which will be used for high pressure fluid storage. Accordingly, it is a general object of the present disclosure to optimize placement of the subterranean zone.

A more specific object creation of the storage zone that prevents vertical fracture propagation.

Yet still a further object of the present disclosure creation of the storage zone in various types (over pressured, under pressured, normally pressured, depleted, etc.) of reservoirs.

These and other objects, features and advantages of this disclosure will be clearly understood through a consideration of the following detailed description.

### SUMMARY OF THE INVENTION

According to an embodiment of the present disclosure, there is provided a method of creating a subterranean zone configured to prevent unwanted fracture propagation in a reservoir. The method consisting of identifying a formation, drilling a wellbore into the zone, characterizing the stresses of the formation, injecting a working fluid, storing it under high pressure, and controlling the injection to maintain propagation.

There is also provided a system for storing energy in a subterranean zone configured to prevent vertical propagation in a reservoir. The system comprises a wellbore extended into a formation, a fluid injection system configured to inject a working fluid, a data and control module for controlling the injection to prevent propagation and a surface facility to convert the stored energy into usable work.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a simplified schematic view of a subterranean fluid storage system according to the principles of an embodiment of the present disclosure.

FIG. 2 is a simplified schematic view of a fluid storage system and surface equipment.

FIG. 3 shows a simplified rock column with a barrier zone and an injection zone.

FIG. 4 is a plot of pressure gradient, fracture gradient and lithostatic pressure gradient as a function of depth.

FIG. 5 is a simplified schematic view of a man-made hydraulic fracture between well bores.

FIG. 6 is a simplified schematic view of man-made hydraulic fractures between subterranean zones.

FIG. 7 is a simplified schematic view of man-made near horizontal hydraulic fractures between subterranean zones.

### DESCRIPTION OF THE PREFERRED EMBODIMENTS

One or more embodiments of the subject disclosure will now be described with the aid of numerous drawings. Unless otherwise indicated, use of specific terms will be understood to include multiple versions and forms thereof.

Subterranean zones are used for geomechanical energy storage. High-pressure fluid is pumped into one or more rock matrices where it is held for a period of time before moving to the surface where hydraulic energy is converted to usable work. The technology was created based on oil and gas hydraulic fracturing techniques in order to utilize the elasticity principles of the rock and the rock's overburden.

The present disclosure is designed to utilize depleted, naturally pressured, or overpressured reservoirs that may or may not require hydraulic fracturing or other techniques to increase permeability. Geomechanical energy storage can utilize any type of rock formation which has any kind of pressure relative to the hydrostatic pressure gradient including over pressured, under pressured, normally pressured, or depleted.

In one embodiment natural fractures might be used to communicate with both the injection well and the production well. In another embodiment natural fractures and man-made fractures could be used to enhance fluid communication between the injection well and the subterranean zone, within the subterranean zone, as well as between the subterranean zone and the production well. Some embodiments herein include a method to create a fracture to enlarge the vertical or near vertical subterranean zone in which to store fluid under pressure. The upper most part of the subterranean zone can be a “lid”, which is a vertical containment mechanism of hydraulic fracture or the fracture network. This natural barrier prevents the fracture from propagating upwards.

The oil and gas industry has used geologic barriers with higher stress layers to mitigate vertical fracture propagation for quite some time. New geomechanical, high-pressure fluid storage systems can use the same geologic barriers to mitigate vertical fracture propagation and limit fluid leakage during hydraulic fracturing and during energy storage. Some of these subterranean zones will require sealing material, some will not. Proppant or other solids may pumped and placed with the hydraulic fracturing treatments.

In some embodiments geomechanical, high-pressure fluid storage systems, will not utilize hydraulic fractures techniques. These systems may also benefit from the geologic barriers to completely eliminate to reduce fluid leakage.

Those skilled in the art will understand that geologic barriers can be horizontal, Sub horizontal or at a significant angle. It is also important to note that geologic barriers for energy storage system could be any orientation or fully encompassing the subterranean zone.

One benefit of creating one or more man-made fractures in the subterranean zone is the additional surface contact area for the working fluid to touch the rock surface and gather heat energy. Likewise, a large natural fracture zone may also contain a large working fluid contact area. Other special geologic features such as caverns, natural barriers, may also include large contact areas for the subterranean surface and the working fluid.

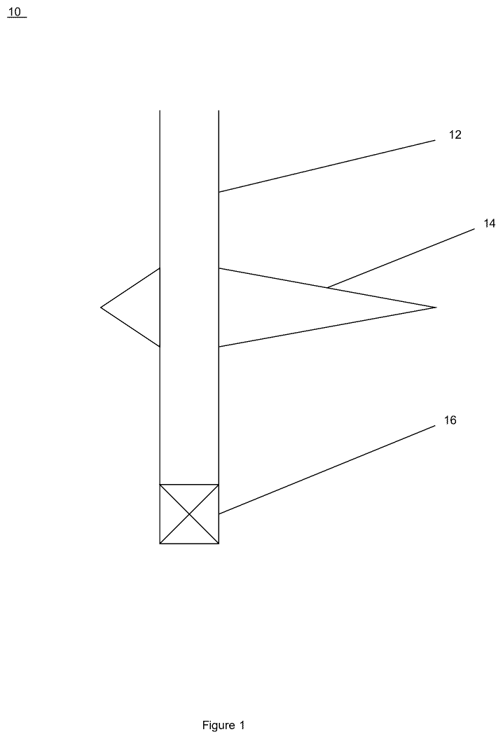

Turning now to the figures, and in particular, FIG. 1, a simplified geomechanical energy storage system 10 including a few sub systems is shown. A well 12, subterranean zone 14, and a plug 16. The subterranean zone 14 may consist of a single fracture which may be sealed or not sealed.

Wells and subterranean zones that were once used for saltwater disposal and have a record of fluid loss rate might be used “as is” or modified and repurposed for energy storage. These subterranean zones might be described as overpressured, normally pressured, underpressured or depleted.

One or more subterranean zones may be connected to one or more wells. Depending on the well bore geometry, spacing, and well completion equipment, injection wells might also be used for production wells. Also, a well initially intended for production might be used for injection. Many factors such as these could be analyzed and optimized as the system, the sub-systems, and their components age and change over time.

In one embodiment additional man-made fractures could be added to an aging network of sub-systems making up the subterranean zone(s) to increase efficiency or capacity for high pressure fluid storage and/or geothermal energy gathering.

In some embodiments it is envisioned that the natural fractures might be limiting in size (length, width, height, etc.) Adding man-made fractures might make the subterranean zone feasible and/or more efficient for either or both: a) high-pressure fluid storage and b) heat gathering.

The invention noted here combines methods to gather and store energy making many different rock types and temperatures suitable for efficient, productive systems. Today's geothermal systems generally only target the highest temperature rock formations and are geographically restricted. The next generation system described here will eliminate that problem by enhancing energy recovery with multiple energy recovery methods Naturally occurring fluidically connected subterranean zones might also be used for energy storage. These subterranean zones might also be described as overpressured, normally pressured, underpressured or depleted.

Indeed, combinations of subterranean zones with different characteristics might be used for or repurposed for energy storage. These subterranean zones might be described as overpressured, normally pressured, underpressured or depleted.

One or more subterranean zones might be used to supply fluid to another subterranean zone to charge, store energy, and/or optimize pressure and volumetric flow rates to optimize usable work output.

Subterranean zones with low conductivity may need stimulation, hydraulic fracturing, proppant, or other modification to become viable solutions for high-pressure fluid storage to be utilized for efficient energy storage.

Multiple zones that are not fluidically connected at the wellbore can be used together similar to commingled production in oil and gas operations. These zones may be completely disconnected hydraulically or may be in hydraulic communication at some point or various points away from the wellbore.

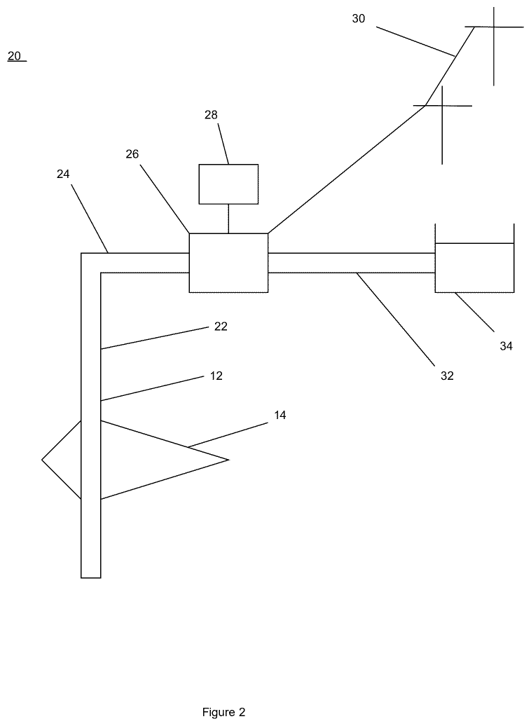

FIG. 2 is a simplified schematic view of a geomechanical energy storage system 20. It includes a high-level overview of the following subsystems including a well 12, subterranean zone 14, wellhead 22, surface pipe 24, surface facilities 26, data acquisition and control module 28, an electric line out 30, surface pipe 32, and low-pressure storage mechanism 34.

One or more wellbores 12 may be utilized to inject or produce at the same time or used at various times and rates. Different types of rock formations in different subterranean zones 14 can be connected to make a high-volume energy storage system. Examples include but are not limited to man-made hydraulic fractures, natural fractures, natural occurring caves, conventional fluvial sandstone reservoirs, deltaic sandstone reservoirs, barrier sandstone reservoirs, or limestone reefs.

Normally pressured zones that can produce enough fluid at the proper pressure and can therefore be used with or without modification. If the geologic barriers are sufficient, these zones can be charged via fluid injection where energy can be stored and released.

A depleted zone in the oil and gas sector is a rock formation that has been used to produce oil and/or gas for a period of time and has transitioned into a less than favorable economic condition for the operator to continue to produce hydrocarbons or other compounds. More than likely the pressure in the zone has dropped significantly from its initial condition. These zones might be used to store waste, produced water, saltwater or other materials. Some of these rock formations may be repurposed for geomechanical energy storage of high-pressure working fluids for the purpose of energy storage. In some instances, rock formations will need to be modified by hydraulically fracturing and/or pumping sealing materials in, to seal potential leaks to make more efficient energy storage possible.

The economics of a subterranean zone depends on the hydraulic capability (i.e. storage volume, volumetric flow rate, pressure, connected pore volume, of the sub systems such as the geologic structure, wellbore size, installed completion, etc. Reservoirs with higher permeability and greater thickness generally result in higher flow rates for longer periods of time.

Software and control systems 28 will be utilized to increase efficiency, track and record data, cost, match electric grid parameters, automate billing and the like. Where necessary, fracture stimulation could be used to increase the hydraulic capacity & conductivity of fluid flow between the reservoir and the wellbore by artificially increasing effective flow area. Increased flow area allows fluid to converge into the wellbore across a larger surface area, as opposed to just the flow area contribution from high perm reservoir thickness.

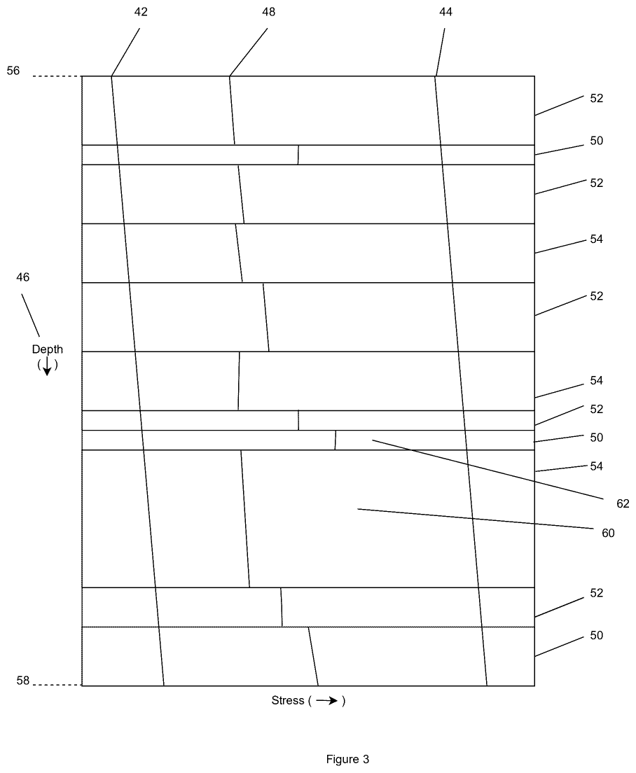

FIG. 3 shows a simplified rock column graph 40 wherein the pore pressure 42 and vertical stress 44 both increase uniformly with depth 46. The minimum horizontal stress 48 varies non-uniformly with depth 46. High-stress zones 50, medium-stress zones 52 and low-stress zones 54 are shown from the surface 56 to the floor 58. The injection zone 60 targeted for the hydraulic fracture energy storage system is the deepest low-stress zone overlain by a high-stress fracture barrier 62. FIG. 3 is a subset of the data pulled from chart 4C in Kohli, A., & Zoback, M. (2021). “Stratigraphically Controlled Stress Variations at the Hydraulic Fracture Test Site-1 in the Midland Basin, TX.”Energies, 14(24), 8328.

Several well drilling techniques can assist in connecting the wellbore to the desired parts of the chosen formation. This list includes but is not limited to rock sampling, directional drilling, various mud systems, measurement while drilling (MWD), horizontal drilling, upward drilling (often referred to as fishhook wells), and the like.

Many different gases or combinations of gases can be used with a working fluid and its additives. These materials can be injected into the subterranean zone and stored under pressure as potential energy. The energy can later be released, the working fluid can flow to the surface to convert energy to useful work. Entrained gas may be kept in solution or separated.

Compressible fluids that might be useful include but are not limited to nitrogen, CO2, air, and hydrocarbons containing gas. An adjacent or distant source like a manufacturing plant, gas well, oil well, water well or separation facility may be useful for supplying material. Incompressible fluids including but not limited to formation water from the energy storage zone, formation water from an overlying or underlying zone, produced water from other sources, sea water, lake water and desalinated water could also be used as working fluid.

Considerations for selecting suitable geologic environments for this system and method include:
1. Formations with sufficient depth such that fractures have the tendency to form in a predominately vertical orientation. These are typically found at depths greater than 1,500 ft in most geographic locations.
2. When fractures are oriented vertically, the directional propagation tendency of the fracture depends on the density of the fluid.
3. When the static density of the fluid imposes a stress in the formation that exceeds the minimum in-situ stress of the formation, then the fracture will have a tendency to propagate downwards. E.g. weighted fluid such a ZnBr.
4. When the density of the fluid imposes a stress in the formation that is less than the minimum in-situ stress of the formation, then the fracture will have a tendency to propagate upwards. Natural barriers may help create this so-called “lid.”
5. It is desirable to pursue formations with high values of fracture toughness as it generally results in energy storage systems with increased efficiency, power density, and energy density.

6. Low permeability formations may be desirable as low permeability helps minimize fluid leakage, and results in a more efficient energy storage system 7. Most depositional environments in sedimentary basins contain variations in in-situ stress as a function of depth. These variations in stresses can occur at interfaces between changing lithology, or even within the same lithology and formation. Relatively large stress contrasts act as barriers against hydraulic fracture propagation. These can be used to select the top of the subterranean zone for fluid storage or the “lid.”
8. Selecting formations whereby sufficiently large stress contrasts exist to halt fracture propagation in the upwards, downwards, or both directions are essential for engineered subsurface energy storage.
9. Halting fracture propagation is important for subsurface energy storage because a propagating fracture provides a means for fluid to leak off. The loss of fluid results in low volumetric recovery and higher system efficiency loss in the energy storage system.
10. By halting fracturing propagation, the extent of the fracture becomes confined while fluid is being injected into the fracture. This may result in better fluid retention and energy storage efficiency.
11. Fluid retention and energy storage efficiency can be further enhanced by injecting fluid loss agents which are designed to inhibit loss of fluid into the matrix, fracture tips, or a combination of both. Sealing materials can reduce fluid loss at the extents of the fracture boundary, in any intersected or created fracture network, or along the stress boundary.
12. Deep fracture-based energy storage can be made possible in the geologic environments where the fracture toughness of the subterranean formation is sufficiently high and/or one or more barriers exist above the fracture system that sufficiently inhibit fracture propagation.

Energy storage can be made possible in the geologic environments where the fracture toughness of the subterranean formation is sufficiently high and/or one or more geologic barriers exist above the subterranean zone to limit system leakage.

Fracture system construction methods may include:

Performing a series of activities to characterize the variations in-situ stresses as a function of depth. These may include core sampling, logging, Diagnostic fracture injection tests (DFITs), Formation Integrity Test (FIT), and Leak-Off Tests (LOT).

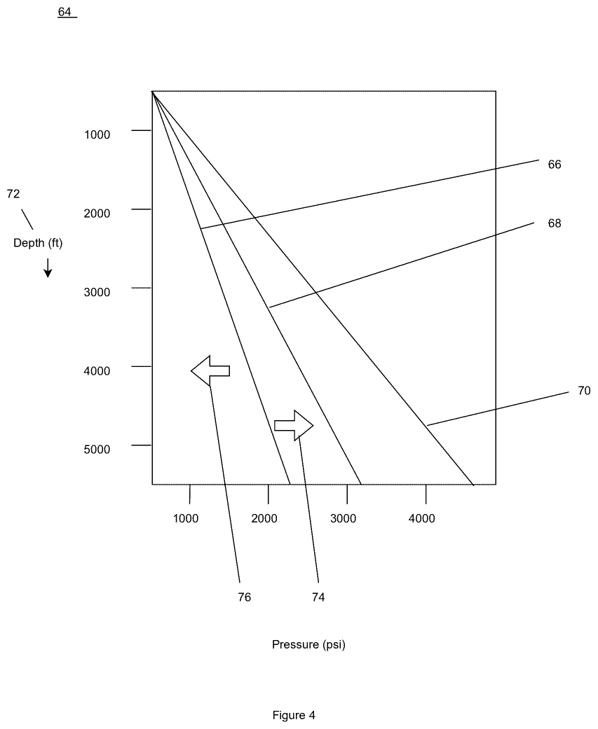

FIG. 4 is a graph 64 showing a plot of pressure gradient 66, fracture gradient 68 and lithostatic pressure gradient 70 as a function of depth 72. Normally lithostatic pressure 70 increases at a faster rate than hydrostatic pressure as shown with the increasing slope of its line. These three gradients are found in the overpressured zone 74 and not within the underpressured zone 76 of the graph 64.

Designing the placement(s) of the wellbore(s) and/or perforations based on the localized in-situ stress. For instance, placing the wellbore and perforations below a point of localized high stress contrast may contain fracture propagation of low-density fluids in the upwards direction. Similarly, placing the wellbore and perforations above a point of high stress contrast may contain fracture propagation of high-density fluids in the downward direction.

One or more subterranean zones may be connected to one or more wells. Depending on the well bore geometry, spacing, and well completion equipment, injection wells might also be used for production wells. Also, a well initially intended for production might be used for injection. Many factors such as these could be analyzed and optimized as the system, the sub-systems, and their components age and change over time.

In one embodiment additional man-made fractures could be added to during a repair phase to an aging network of sub-systems making up the subterranean zone(s) to increase efficiency or capacity for high pressure fluid storage and/or geothermal energy gathering.

Artificially engineering the shape and dimensions of a fracture by introducing, into the subterranean formation, a fluid of varying density and/or viscosity, such that it imposes localized stresses that are equal to, greater than, or less than, the minimum in-situ stress of the formation.

Fluids, solids, or a combination of both, may be used to enhance hydraulic conductivity of the subterranean formation and fracture network.

Geologic parameters, such as in-situ stress, permeability, etc., influence the design of the fluid system used to create the fracture energy storage system. Attributes of the fluid system design may include particle size distribution, solids concentration, material selection, fluid selection, fluid rheology, fluid volumes, suspension time of solids, filter cake permeability, etc. Optimizing the fluid system design may be required to create a high efficiency energy storage system. Failure to do so could lead to undesired consequences such as, but not limited to, premature tip screen out, failure of slurry material to remain in the fracture system during operations, loss of fracture conductivity, excessive fluid leakage, etc.

If the hydraulic fracture is created in a low-permeability formation underlying a fracture barrier where the least principal stress is the minimum horizontal stress, the fracture will be prevented from growing vertically upwards beyond the fracture barrier. The majority of fracture propagation would occur laterally. While minimal fluid leak-off is to be expected in a low-permeability formation, lateral fracture growth would allow for a more simplistic application of leak-off prevention materials, if required, compared to more complex vertical fractures.

One of the primary attributes of this invention is that the geologic barrier is a pre-existing geological phenomenon. Sealing material could potentially reduce leak off at the boundary of the lid, lateral extents, rock pores, or prevent leak off in the fracture network.

A large amount of energy may be used to pump the fluid into the one or more subterranean zones and fractures. Such pressure may be converted to mechanical work when the fluid returns to the surface. Some of such pressure may be used to produce electricity. For instance, the pressure may be used to generate electricity by turning a shaft on a generator.

There are many other combinations of wells and subterranean zones that might be mixed and matched. Each well, as well as each subterranean zone may have different specifications, working limitations, flow capabilities, pressure ratings, temperatures, fluid compatibilities, etc.

In other embodiments, the injection well might be in the center of a field with one or more subterranean zones connected to an outer ring of production wells that allow working fluids to move from the center, through one or more subterranean zones to one or more production wells located in an optimized outer ring. These systems might be optimized for heat transfer from the subterranean zone(s) to the working fluids as they move from the injection well to one or more production wells. Alternatively, the injection wells around the outer ring could be used for injection and the center well could be used for production. Either of these configurations might be optimal for high pressure fluid storage and heat transfer to the working fluid. The system characteristics may change over time, driving a different combination of flow paths to maximize system output.

Man-made hydraulic fractures can be added between well bores, fracture networks, subterranean zones, or any combination of these features. They can be placed and directed with existing fracture technology and fluid treatment techniques. In some embodiments synergy storage systems can utilize these methods to enlarge system volume, add sub-systems, fluidically link sub-systems, increase efficiency, repair and/or replace old, worn, or low performance features.

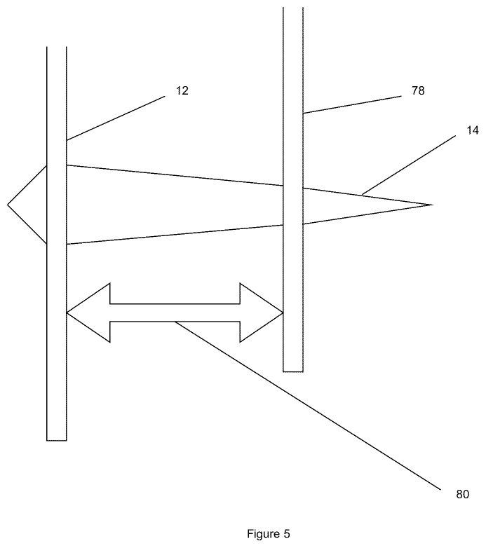

FIG. 5 illustrates horizontal, are nearly horizontal, man-made hydraulic fractures 80 between two well bores (12, 78). The second well 78 may intersect near the middle section of the subterranean zone 14. This and other well placement relative the zone 14 may be a design feature to be optimized for heat energy gathering as well as the reduction of fluid friction and other effects.

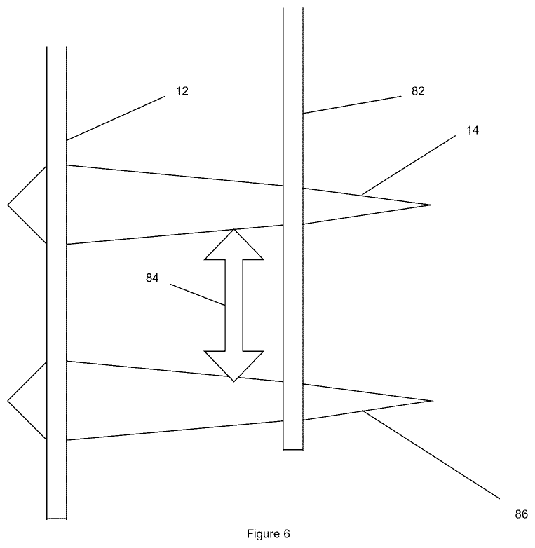

FIG. 6 shows a vertical, or near vertical, man-made hydraulic fracture 84 between two subterranean zones (14, 86). This system is very similar to a typical hot, dry rock, geothermal, electricity generation system as is typically found in the western United States. During the construction phase or during re-work phase man made, hydraulic fractures 84 could be placed between subterranean zones as shown. Such fractures can be vertical, near vertical, horizontal, or near horizontal. This is performed to improve conductivity, flow rate, and energy storage volume.

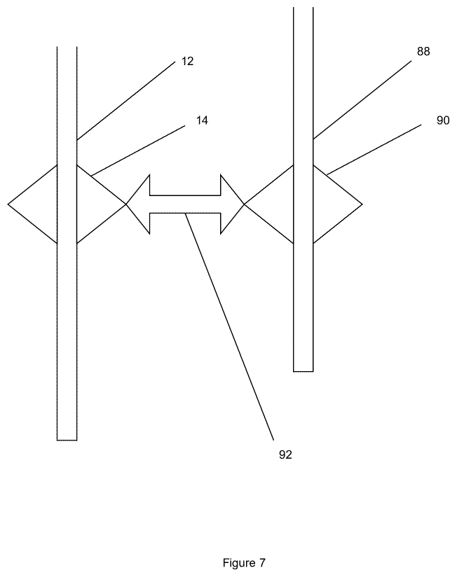

Finally, FIG. 7 shows horizontal, or near horizontal, man-made hydraulic fractures 92 between two subterranean zones 14 and 90 having their own well bores 12 and 88.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention in its broader aspects, and, therefore, the aim in the appended claims is to cover all such changes and modifications as fall within the true spirit and scope of the present disclosure.

What is claimed is:

1. A method for creating a subterranean energy storage zone configured to store high-pressure fluid while limiting leakage in a reservoir, comprising:
identifying a subterranean zone having a geomechanical or geological barrier with mechanical or capillary sealing capacity sufficient to withstand a stress or pressure differential between said barrier and said storage zone, wherein said barrier is a pre-existing geological feature that inhibits fluid leakage;
positioning one or more subterranean zones in a lower-stress or lower-pressure injection zone of the subterranean formation wherein the subterranean formation is selected from the group consisting of overpressured reservoirs, normally pressured reservoirs, under-pressured reservoirs, depleted reservoirs, and combinations thereof;
injecting a working fluid into the lower-stress or lower-pressure injection zone through at least one wellbore to create or enhance a subterranean energy storage zone, wherein the working fluid is stored under a higher pressure; and
using existing geological barriers for limiting the leakage of the higher-pressure working fluid.

2. The method of claim 1, further comprising cycling said working fluid into and out of one or more subterranean zones and wells to perform useful work.

3. The method of claim 1, wherein the subterranean energy storage zone comprises at least one feature selected from the group consisting of man-made hydraulic fractures, natural fractures, naturally occurring caves, fluvial sandstone reservoirs, deltaic sandstone reservoirs, barrier sandstone reservoirs and limestone reefs or other fluidically connected geologic features and/or combinations thereof.

4. The method of claim 1, wherein the working fluid comprises a compressible fluid selected from the group consisting of nitrogen, carbon dioxide, air and hydrocarbons.

5. The method of claim 1, wherein the working fluid comprises an incompressible fluid selected from the group consisting of formation water, produced water, waste water, seawater, lake water and desalinated water.

6. The method of claim 1, further comprising hydraulically fracturing the lower-stress or lower-pressure injection zone to increase permeability and hydraulic conductivity prior to injecting the working fluid, wherein hydraulically fracturing includes injecting a fluid system optimized for the subterranean formation.

7. The method of claim 1, wherein the at least one wellbore is drilled using a technique selected from the group consisting of directional drilling, horizontal drilling, upward drilling, and combinations thereof to connect the wellbore to the low-stress injection zone.

8. The method of claim 1, further comprising releasing at least a portion of the stored working fluid from the subterranean energy storage zone to a surface facility to perform useful work, wherein the useful work includes generating electricity using a turbine-generator system.

9. The method of claim 6, wherein controlling the injection of the fracturing fluid includes selecting a fluid density to influence fracture propagation direction, wherein:
a fracturing fluid with a static density that imposes a stress greater than a minimum in-situ stress of the subterranean formation promotes downward fracture propagation; and
a fracturing fluid with a static density that imposes a stress less than the minimum in-situ stress of the subterranean formation promotes upward fracture propagation, wherein the high-stress fracture barrier halts upward fracture propagation.

10. The method of claim 1, wherein the at least one wellbore includes a plurality of wellbores configured to operate as injection wells, production wells, or a combination thereof, based on system demands and subterranean zone characteristics.

11. A system for storing and releasing energy using a high-pressure working fluid in a subterranean formation, the system comprising:
a lower-stress injection zone within the subterranean formation configured to store the high-pressure working fluid for a period of time; and
a higher-stress fracture barrier overlying said lower-stress injection zone, said higher-stress fracture barrier being a pre-existing geological barrier configured to limit fracture propagation induced by a fracturing fluid in said lower-stress injection zone and reduce or eliminate leakage of the high-pressure working fluid stored in the lower-stress injection zone wherein the system is configured to return the high-pressure working fluid to the surface to perform usable work.

12. The system of claim 11, wherein the said subterranean formation has a rock pore pressure.

13. The system as defined in claim 12 wherein said pressure is over pressured, under pressured, depleted or normal.

14. The system of claim 11 wherein the fluid injection system is further configured to inject a sealing material into the subterranean energy storage zone to reduce fluid leak-off at one or more locations.

16. The system of claim 14, wherein the subterranean energy storage zone comprises at least one feature selected from the group consisting of man-made hydraulic fractures, natural fractures, naturally occurring caves, fluvial sandstone reservoirs, deltaic sandstone reservoirs, barrier sandstone reservoirs, limestone reefs, and combinations thereof.

17. The system of claim 14, wherein the working fluid comprises a compressible fluid selected from the group consisting of nitrogen, carbon dioxide, air, hydrocarbons, and combinations thereof, or an incompressible fluid selected from the group consisting of formation water, produced water, seawater, lake water, desalinated water, and combinations thereof.

18. The system of claim 14, further comprising a hydraulic fracturing system configured to increase permeability and hydraulic conductivity of the low-stress injection zone by injecting a fluid system into the low-stress injection zone, wherein the fluid system is optimized for the subterranean formation based on attributes including at least one of particle size distribution, solids concentration, material selection, fluid selection, fluid rheology, fluid volume, suspension time of solids, and filter cake permeability.

19. The system of claim 11, further comprising a low-pressure storage mechanism fluidically connected to the at least one wellbore, wherein the low-pressure storage mechanism is configured to store the working fluid after release from the subterranean energy storage zone.

20. The system of claim 11, wherein the fluid injection system is configured to inject the fracturing fluid with a density selected to control fracture propagation direction, wherein:
a fracturing fluid with a density that imposes a stress greater than a minimum in-situ stress of the subterranean formation promotes downward fracture propagation; and
a fracturing fluid with a density that imposes a stress less than the minimum in-situ stress of the subterranean formation promotes upward fracture propagation, wherein the high-stress fracture barrier halts upward fracture propagation.
